(19) United States
(12) Patent Application Publication
(10) Pub. No.: US 2024/0295092 A1
(43) Pub. Date: Sep. 5, 2024

(54) ICE MELT SYSTEM

(71) Applicant: Nicholas Condoll, Wayne, MI (US)

(72) Inventor: Nicholas Condoll, Wayne, MI (US)

(21) Appl. No.: 18/116,811

(22) Filed: Mar. 2, 2023

(51) Int. Cl. E01H 10/00; B05B 3/02; B05B 9/04; B05B 12/12

(52) U.S. Cl. CPC E01H 10/005; B05B 3/02; B05B 9/0423; B05B 12/12

(57) ABSTRACT

An ice melt system for melting accumulated ice off of a surface includes a reservoir which has an outer wall and is hollow. An ice melting solution is stored in the reservoir. A pump is in fluid communication with the reservoir for selectively pumping the ice melting solution out of the reservoir, and a piping is fluidly coupled to and extends away from the pump. A plurality of dispensing assemblies is fluidly coupled to the piping and is positioned adjacent to a surface to be treated. Each dispensing assembly of the plurality of dispensing assemblies comprises a nozzle which is in fluid communication with the piping for dispensing the ice melting solution. The nozzle is orientable such that the nozzle is configured for dispensing the ice melting solution over the surface to be treated.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to ice melt systems and more particularly pertains to a new ice melt system for melting accumulated ice off of a surface.

### (2) Description of Related Art Including Information Disclosed Under 37 CFR 1.97 and 1.98

The prior art includes myriad carts and similar tools for moving over a surface to dispense an ice melting solution to melt ice accumulated on the surface. However, the prior art fails to disclose an ice melt system which pumps the ice melting solution from a reservoir through piping to a plurality of dispensing assemblies which direct the ice melting solution onto the surface. The prior art also fails to describe a motion sensor being used in such an ice melting system to detect when a person, vehicle, or other obstruction is near the surface to be treated and deactivate the pump so as to avoid spraying the obstruction with the solution.

### BRIEF SUMMARY OF THE INVENTION

An embodiment of the disclosure meets the needs presented above by generally comprising a reservoir which has an outer wall and is hollow. An ice melting solution is stored in the reservoir. A pump is in fluid communication with the reservoir for selectively pumping the ice melting solution out of the reservoir, and a piping is fluidly coupled to and extends away from the pump. A plurality of dispensing assemblies is fluidly coupled to the piping and is positioned adjacent to a surface to be treated. Each dispensing assembly of the plurality of dispensing assemblies comprises a nozzle which is in fluid communication with the piping for dispensing the ice melting solution. The nozzle is orientable such that the nozzle is configured for dispensing the ice melting solution over the surface to be treated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an ice melt system according to an embodiment of the disclosure.

FIG. 2 is a top view of an embodiment of the disclosure.

FIG. 3 is a detail perspective view of a dispensing assembly of an embodiment of the disclosure.

FIG. 4 is a detail perspective view of a reservoir of an embodiment of the disclosure.

FIG. 5 is a block diagram of an embodiment of the disclosure.

FIG. 6 is an in-use view of a controller of an embodiment of the disclosure.

FIG. 7 is a detail front view of a dispensing assembly of an embodiment of the disclosure.

FIG. 8 is a cross-sectional view of a dispensing assembly of an embodiment of the disclosure taken from Arrows 8-8 in FIG. 7.

### DETAILED DESCRIPTION OF THE INVENTION

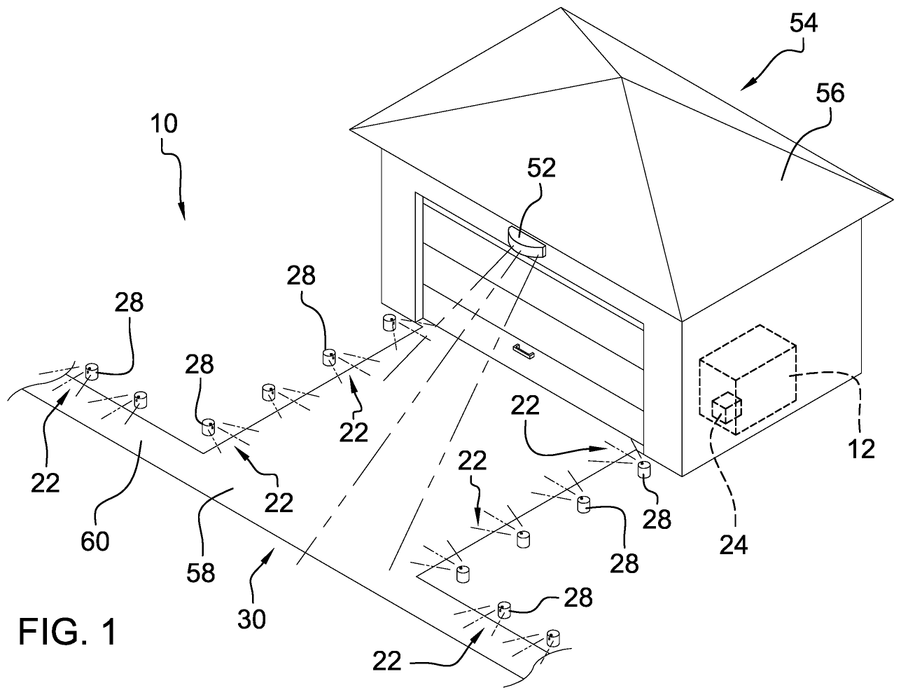

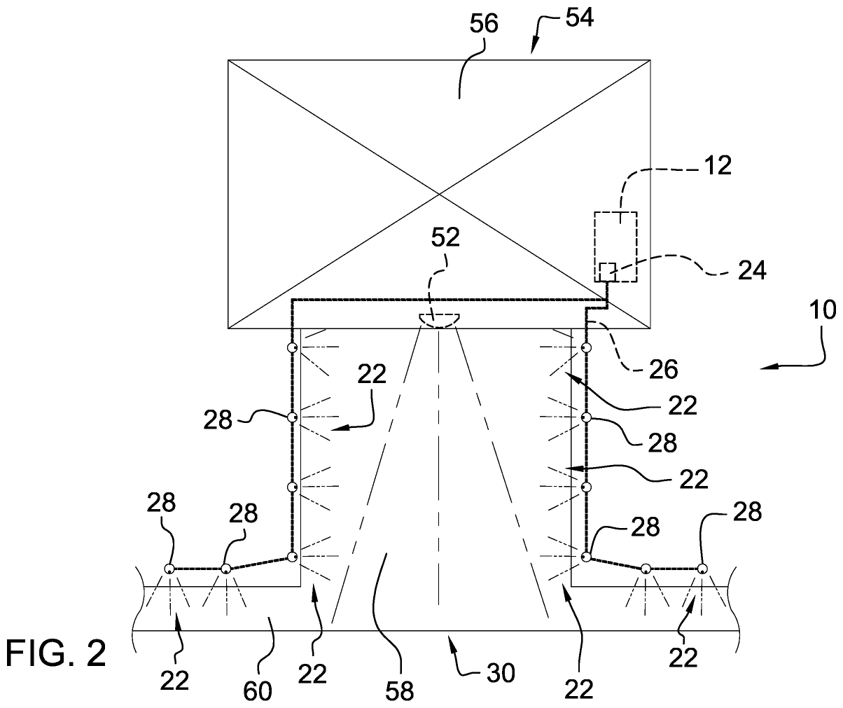

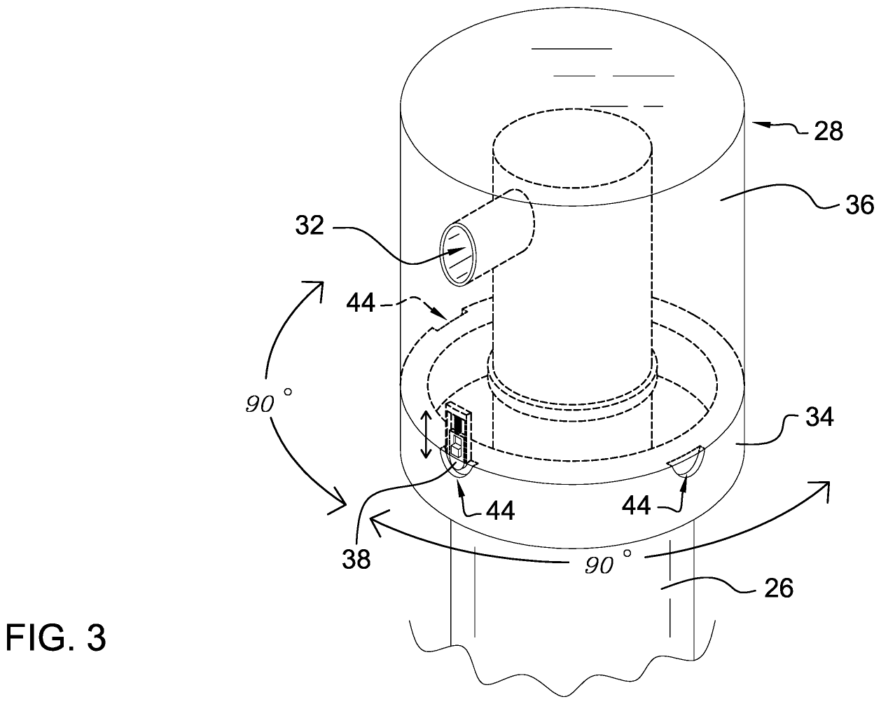

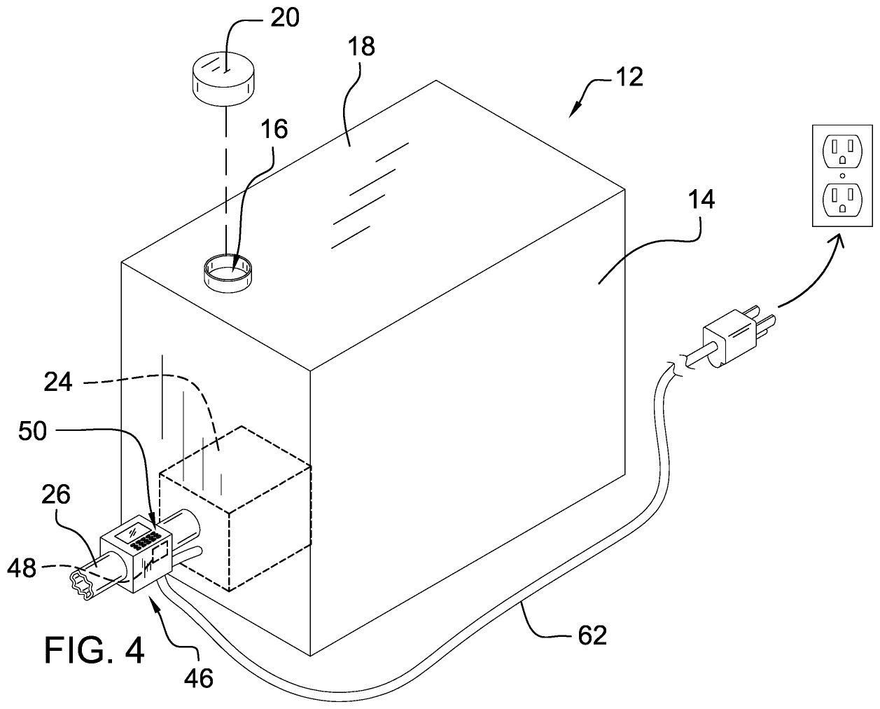

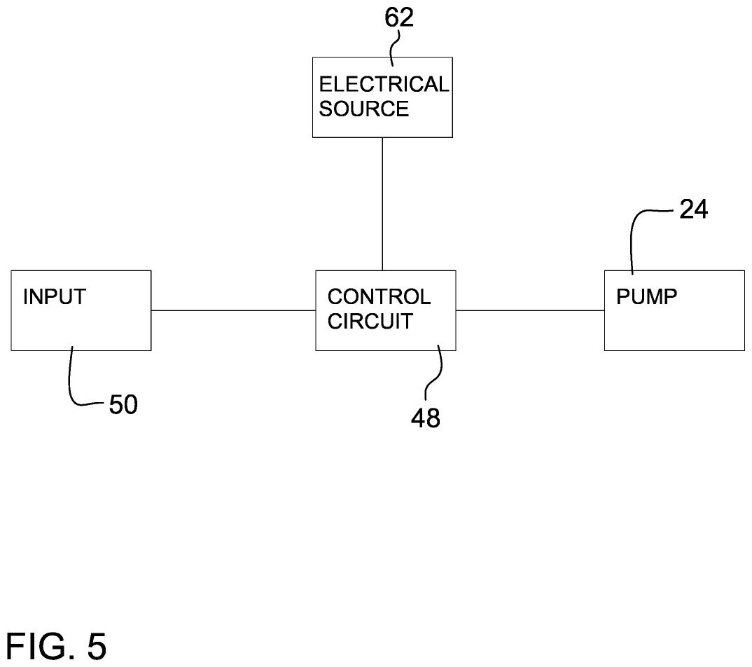

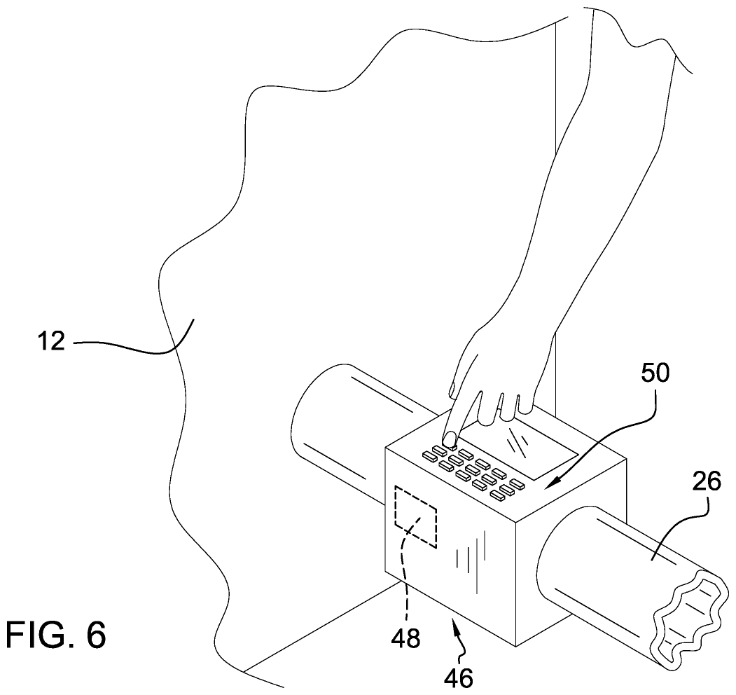

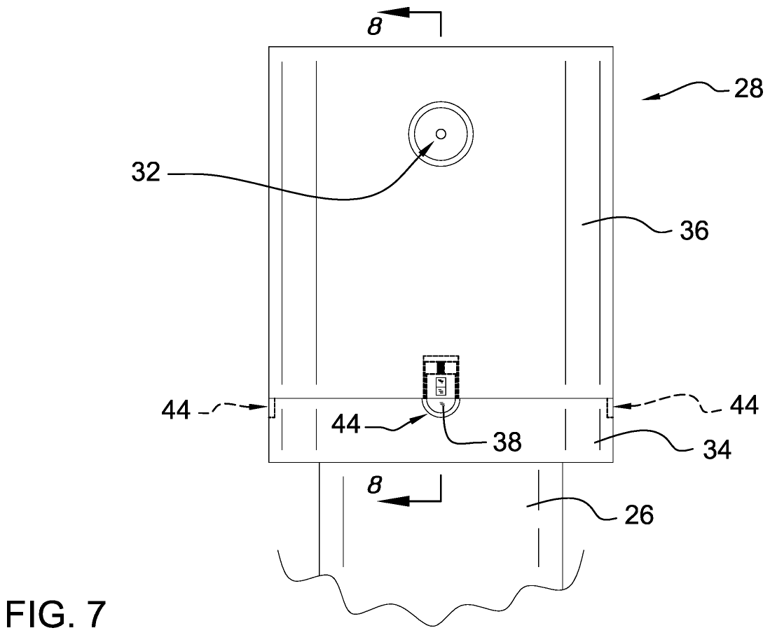

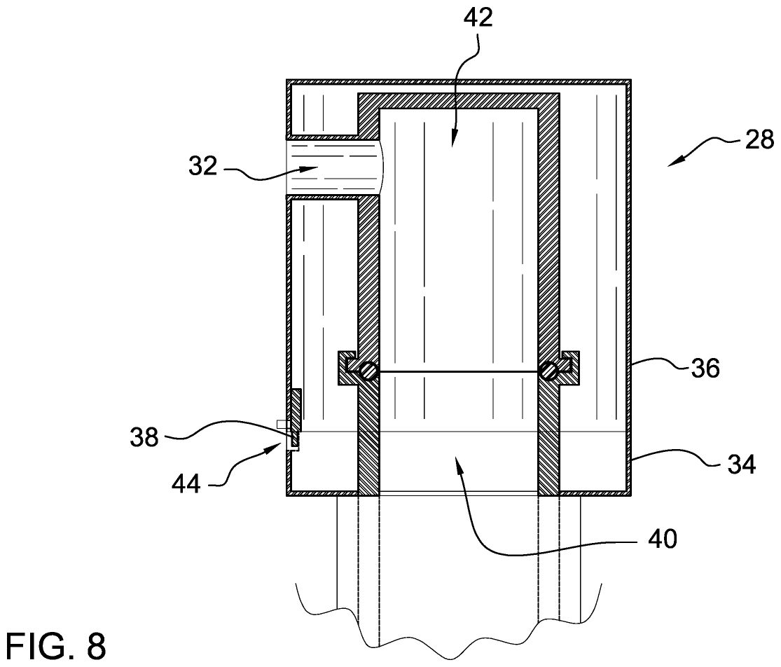

With reference now to the drawings, and in particular to FIGS. 1 through 8 thereof, a new ice melt system embodying the principles and concepts of an embodiment of the disclosure and generally designated by the reference numeral 10 will be described.

As best illustrated in FIGS. 1 through 8, the ice melt system 10 generally comprises a reservoir 12 which has an outer wall 14 and is hollow. The reservoir 12 has a fill opening 16 extending through a top portion 18 of the outer wall 14, and a cap 20 is removably positionable to cover the fill opening 16 of the reservoir 12. An ice melting solution 22 is stored in the reservoir 12. A pump 24 is in fluid communication with the reservoir 12 and positioned in the reservoir 12 for selectively pumping the ice melting solution 22 out of the reservoir 12. A piping 26 is fluidly coupled to and extends away from the pump 24. The piping 26 extends out of the reservoir 12 to each dispensing assembly 28 of a plurality of dispensing assemblies 28 positioned adjacent to a surface 30 to be treated.

Each dispensing assembly 28 of the plurality of dispensing assemblies 28 is fluidly coupled to the piping 26 and comprises a nozzle 32, a base 34, a head 36, and a detent 38. The nozzle 32 is in fluid communication with the piping 26 for dispensing the ice melting solution 22 and is orientable to dispense the ice melting solution 22 over the surface 30 to be treated. The base 34 is coupled to the piping 26, and the head 36 is pivotally coupled to the base 34. The nozzle 32 is positioned in the head 36. A first channel 40 extends through the base 34 and a second channel 42 extends through the head 36 fluidly couple the nozzle 32 to the piping 26. The head 36 is pivotable to adjust an orientation of the nozzle 32. A detent 38 is coupled to the head 36, and the base 34 has a plurality of recesses 44 positioned for receiving the detent 38. The detent 38 is biased to extend into a selected recess 44 of the plurality of recesses 44 such that the head 36 is secured to the base 34. The plurality of recesses 44 includes three recesses 44 which are spaced in 90-degree intervals. Each dispensing assembly 28 may include a flow regulator which is adjustable to adjust the range of the respective dispensing assembly 28.

The reservoir 12 may be stored in a building 54 such as a garage 56, and the piping 26 may be arranged to run underground to each dispensing assembly 28 of the plurality of dispensing assemblies 28. The surface 30 to be treated may include, for example, a driveway 58 and a sidewalk 60. The surface 30 also may include a parking lot, a parking ramp driving surface, or the like.

A controller 46 is electrically coupled to the pump 24 and includes a control circuit 48. The controller 46 is mounted to the piping 26 adjacent to the pump 24. An input 50 is electrically coupled to the control circuit 48 and is mounted to the controller 46. An electrical cord 62 may be electrically coupled to the controller 46 such that the controller 46 is electrically couplable to an external electrical power source. The input 50 is operable to program the controller 46 to activate the pump 24 at a selected time for a selected duration. The controller 46 may be programmed to operate on a repeating schedule. A motion sensor 52 is electrically coupled to the controller 46 and is programmed to detect motion from an obstruction adjacent to the surface 30 to be treated. The controller 46 is programmed to deactivate the pump 24 when the motion sensor 52 detects motion. The motion sensor 52 may be a passive infrared sensor, a microwave motion detector, an ultrasonic motion detector, or the like.

In use, the controller 46 is programmed to operate the pump 24 at the selected time for the selected duration. When the pump 24 is activated, it urges the ice melting solution 22 through the piping 26 to each dispensing assembly 28 of the plurality of dispensing assemblies 28, which dispenses the ice melting solution 22 onto the surface 30 to be treated. The ice melting solution 22 will act on accumulated ice on the surface 30 to melt the ice. If the motion sensor 52 detects motion, the pump 24 will be deactivated. The controller 46 may be programmed to activate the pump 24 automatically a period of time after the motion sensor 52 detected motion.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An ice melt system comprising:
a reservoir, the reservoir having an outer wall and being hollow;
an ice melting solution stored in the reservoir;
a pump being in fluid communication with the reservoir for selectively pumping the ice melting solution out of the reservoir;
a piping being fluidly coupled to and extending away from the pump; and
a plurality of dispensing assemblies being fluidly coupled to the piping, each dispensing assembly of the plurality of dispensing assemblies being configured for being positioned adjacent to a surface to be treated, each dispensing assembly of the plurality of dispensing assemblies comprising a nozzle being in fluid communication with the piping for dispensing the ice melting solution, the nozzle being orientable such that the nozzle is configured for dispensing the ice melting solution over the surface to be treated.

2. The system of claim 1, wherein the pump is positioned in the reservoir, the piping extending out of the reservoir.

3. The system of claim 1, wherein each dispensing assembly of the plurality of dispensing assemblies comprises:
a base being coupled to the piping, the base having a first channel extending through the base, the first channel being in fluid communication with the piping; and
a head being pivotally coupled to the base, the head having a second channel extending through the head, the second channel being in fluid communication with the first channel and the nozzle, the head being pivotable to adjust an orientation of the nozzle.

4. The system of claim 3, wherein each dispensing assembly of the plurality of dispensing assemblies further comprises a detent being coupled to the head, the base having a plurality of recesses positioned for receiving the detent, the detent being biased to extend into a selected recess of the plurality of recesses such that the head is secured to the base.

5. The system of claim 4, wherein the plurality of recesses is spaced in 90-degree intervals.

6. The system of claim 4, wherein the plurality of recesses includes three recesses.

7. The system of claim 1, further comprising:
a controller being electrically coupled to the pump, the controller including a control circuit, the controller being mounted to the piping adjacent to the pump; and
an input being electrically coupled to the control circuit, the input being mounted to the controller, the input being operable to program the controller to activate the pump at a selected time for a selected duration.

8. The system of claim 7, further comprising a motion sensor being electrically coupled to the controller, the motion sensor being programmed such that the motion sensor is configured to detect motion from an obstruction adjacent to the surface to be treated, the controller being programmed to deactivate the pump when the motion sensor detects motion.

9. The system of claim 1, wherein the reservoir has a fill opening extending through a top portion of the outer wall, the ice melt system further comprising a cap being removably positionable to cover the fill opening of the reservoir.

10. An ice melt system comprising:
a reservoir, the reservoir having an outer wall and being hollow, the reservoir having a fill opening extending through a top portion of the outer wall;
an ice melting solution stored in the reservoir;
a pump being in fluid communication with the reservoir for selectively pumping the ice melting solution out of the reservoir, the pump being positioned in the reservoir;
a piping being fluidly coupled to and extending away from the pump, the piping extending out of the reservoir;
a plurality of dispensing assemblies being fluidly coupled to the piping, each dispensing assembly of the plurality of dispensing assemblies being configured for being positioned adjacent to a surface to be treated, each dispensing assembly of the plurality of dispensing assemblies comprising:
a nozzle being in fluid communication with the piping for dispensing the ice melting solution, the nozzle being orientable such that the nozzle is configured for dispensing the ice melting solution over the surface to be treated;
a base being coupled to the piping, the base having a first channel extending through the base, the first channel being in fluid communication with the piping;
a head being pivotally coupled to the base, the head having a second channel extending through the head, the second channel being in fluid communication with the first channel and the nozzle, the head being pivotable to adjust an orientation of the nozzle;
a detent being coupled to the head, the base having a plurality of recesses positioned for receiving the detent, the detent being biased to extend into a selected recess of the plurality of recesses such that the head is secured to the base, the plurality of recesses being spaced in 90-degree intervals, the plurality of recesses including three recesses;
a controller being electrically coupled to the pump, the controller including a control circuit, the controller being mounted to the piping adjacent to the pump;
an input being electrically coupled to the control circuit, the input being mounted to the controller, the input being operable to program the controller to activate the pump at a selected time for a selected duration;
a motion sensor being electrically coupled to the controller, the motion sensor being programmed such that the motion sensor is configured to detect motion from an obstruction adjacent to the surface to be treated, the controller being programmed to deactivate the pump when the motion sensor detects motion; and
a cap being removably positionable to cover the fill opening of the reservoir.
